(19) United States
(12) Patent Application Publication
(10) Pub. No.: US 2026/0177083 A1
(43) Pub. Date: Jun. 25, 2026

(54) HYDRAULIC DRIVE SYSTEM

(71) Applicant: Hamm AG, Tirschenreuth (DE)

(72) Inventor: Thomas KLEIN, Mitterteich (DE)

(21) Appl. No.: 19/424,464

(22) Filed: Dec. 18, 2025

(30) Foreign Application Priority Data
Dec. 19, 2024 (DE) 102024138812.9

(51) Int. Cl. F15B 15/18; F15B 13/02; F15B 21/00

(52) U.S. Cl. CPC F15B 15/18; F15B 13/027; F15B 21/005

(57) ABSTRACT

A hydraulic drive system 24, in particular for a self-propelled construction machine, comprises at least one hydraulic pump (28) drivable by a drive unit (26) for conveying hydraulic fluid, a hydraulic circuit (30) receiving hydraulic fluid conveyed by the at least one hydraulic pump (28) and returning hydraulic fluid to the at least one hydraulic pump, at least one hydraulic motor (32, 34) supplied via the hydraulic circuit (30) with hydraulic fluid conveyed by the at least one hydraulic pump (28), a discharge line arrangement (52) for discharging hydraulic fluid from the hydraulic circuit (30) to a hydraulic fluid reservoir (42), at least one flushing line (64) supplied from the hydraulic circuit (30) for flushing at least one hydraulic component of the hydraulic drive system (40) with hydraulic fluid, wherein at least one flushing line (64) branches off from the discharge line arrangement (52) and/or forms a line region of the discharge line arrangement (52).

The present invention relates to a hydraulic drive system which is used, for example, in a construction machine, such as a ground compactor, to drive the construction machine to move over a substrate and/or to supply working devices of the construction machine with hydraulic fluid for operating the same.

Hydraulic drive systems used to operate construction machinery generally comprise at least one hydraulic pump drivable by a drive unit, for example a diesel unit or an electric motor, for conveying hydraulic fluid, a hydraulic circuit receiving hydraulic fluid conveyed by the at least one hydraulic pump and returning hydraulic fluid to the at least one hydraulic pump, and at least one hydraulic motor supplied via the hydraulic circuit with hydraulic fluid conveyed by the at least one hydraulic pump, by means of which, for example, one or more drive wheels or one or more ground processing rollers are driven. During operation of such hydraulic components of the hydraulic drive system, such as hydraulic pumps or hydraulic motors, heat is generated which must be dissipated from the region of these hydraulic components. For this purpose, hydraulic fluid can be extracted from the hydraulic circuit in order to pass it through the hydraulic components to be cooled, for example in parallel with the hydraulic fluid supplied to one or more hydraulic motors. This means that the amount of hydraulic fluid pumped into the hydraulic circuit by one or more hydraulic pumps is determined by the amount of hydraulic fluid required to operate one or more hydraulic motors and the amount of hydraulic fluid required to cool one or more hydraulic components.

Due to the comparatively high fluid pressure of the hydraulic fluid conveyed by the at least one hydraulic pump or supplied into the hydraulic circuit, comparatively high power losses arise when a portion of this hydraulic fluid, which is under comparatively high pressure, is diverted to cool one or more hydraulic components of the hydraulic drive system. Furthermore, the amount of fluid under comparatively high pressure that can be passed through the hydraulic components to be cooled or flushed is limited in order to avoid an excessive increase in pressure in the hydraulic components through which the hydraulic fluid used for flushing or cooling flows, particularly during cold start phases when the hydraulic fluid is comparatively viscous, generally hydraulic oil. Due to this limitation of the amount of hydraulic fluid branched out of the hydraulic circuit, which is necessary in consideration of the pressure limitation during cold start phases, there is a risk that at higher temperatures insufficient hydraulic fluid will be pumped through the hydraulic components to be cooled.

It is the object of the present invention to provide a hydraulic drive system, in particular for a construction machine, such as a ground compactor, in which efficient cooling of hydraulic components of the hydraulic drive system is possible with low power losses.

According to the invention, this object is achieved by a hydraulic drive system, in particular for a self-propelled construction machine, comprising:
at least one hydraulic pump driven by a drive unit for conveying hydraulic fluid,
a hydraulic circuit receiving hydraulic fluid conveyed by the at least one hydraulic pump and returning hydraulic fluid to the at least one hydraulic pump,
at least one hydraulic motor supplied via the hydraulic circuit with hydraulic fluid conveyed by the at least one hydraulic pump,
a discharge line arrangement for discharging hydraulic fluid from the hydraulic circuit to a hydraulic fluid reservoir,
at least one flushing line supplied from the hydraulic circuit for flushing at least one hydraulic component of the hydraulic drive system with hydraulic fluid.

At least one flushing line branches off from the discharge line arrangement and/or forms a line region of the discharge line arrangement.

In the hydraulic drive system constructed according to the invention, hydraulic fluid discharged to the hydraulic fluid reservoir, which generally has a comparatively low pressure, is used to flush or cool one or more hydraulic components. The risk of mechanical overload of hydraulic components to be cooled due to excessive pressure of the hydraulic fluid used for cooling can thus be significantly reduced. Furthermore, it is not necessary to increase the delivery rate of at least one hydraulic pump accordingly in order to provide the hydraulic fluid used for cooling hydraulic components, since the hydraulic fluid used according to the invention is to be discharged from the hydraulic circuit anyway, i.e. is to be diverted from it in the direction of the hydraulic fluid reservoir. This results in a comparatively low power loss required to cool one or more hydraulic components.

In a particularly advantageous embodiment, in particular when taking into account the hydraulic fluid pressure, it is proposed that the discharge line arrangement comprises a discharge cooling line containing a hydraulic fluid cooler and leading to the hydraulic fluid reservoir, and a discharge bypass line leading parallel to the discharge cooling line to the hydraulic fluid reservoir, and that at least one flushing line branching off from the discharge line arrangement branches off from the discharge cooling line and/or forms a line region of the discharge cooling line. The hydraulic fluid cooler provided in such a discharge cooling line is also a component that is pressure-sensitive and must not be subjected to excessive hydraulic fluid pressure. Since in such a drive system it is ensured that the hydraulic fluid pressure of the hydraulic fluid supplied into the discharge cooling line and conducted via this to the hydraulic fluid reservoir does not exceed a predetermined pressure, it is simultaneously ensured that the hydraulic fluid used to cool at least one hydraulic component has a comparatively low hydraulic fluid pressure which excludes the potential risk of damage to the same.

At least one flushing line can branch off from the discharge cooling line upstream of the hydraulic fluid cooler and/or form a line region of the discharge cooling line upstream of the hydraulic fluid cooler. This enables such a structure in which at least one flushing line is arranged parallel to the hydraulic fluid cooler, so that this flushing line and the hydraulic fluid cooler are each flowed through by a part of the hydraulic fluid flowing through the discharge cooling line. This allows the hydraulic fluid pressure acting on a hydraulic component to be cooled to be further reduced.

Alternatively or additionally, it can be provided that at least one flushing line can branch off from the discharge cooling line downstream of the hydraulic fluid cooler and/or form a line region of the discharge cooling line downstream of the hydraulic fluid cooler. This embodiment utilizes the particular advantage that the hydraulic fluid flowing into the flushing line is already cooled in the hydraulic fluid cooler located further upstream and can thus be used particularly efficiently for cooling the at least one hydraulic component associated with this flushing line.

Regardless of whether a flushing line branches off from the discharge cooling line upstream or downstream of the hydraulic fluid cooler, at least one flushing line can be arranged in series with the hydraulic fluid cooler.

In order to be able to release or block the flow through the discharge bypass line in a defined manner and thereby to be able to adjust the proportion of hydraulic fluid flowing through the discharge cooling line and thus mechanically loading the hydraulic fluid cooler, a bypass valve can be associated with the discharge bypass line, wherein the bypass valve is adjustable between a closed position that closes off the discharge bypass line, preferably completely, against flow of hydraulic fluid and an open position that releases the discharge bypass line for flow of hydraulic fluid, preferably to the maximum extent.

In order to avoid mechanical overloading of the hydraulic fluid cooler due to excessive hydraulic fluid pressure, it is advantageous if the bypass valve is adjustable depending on a hydraulic fluid temperature, for example, of hydraulic fluid flowing through the discharge line arrangement.

In particular, it can be provided for this purpose that the bypass valve is open for flow, preferably to a maximum extent, when the hydraulic fluid temperature is below a switching temperature and is at least partially, preferably completely, closed against flow when the hydraulic fluid temperature is above the switching temperature. If the hydraulic fluid has a comparatively high temperature, it generally has a lower fluid pressure due to its lower viscosity, so that at higher hydraulic fluid temperatures, mechanical overload of the hydraulic fluid cooler can essentially be ruled out. Since, at a lower temperature of the hydraulic fluid, a large part of the discharged hydraulic fluid can flow through the discharge bypass line by opening the bypass valve, the pressure of the hydraulic fluid in the discharge line arrangement can be reduced or maintained at a low pressure level even with comparatively viscous hydraulic fluid, so that any part of the comparatively cold and thus viscous hydraulic fluid still flowing through the hydraulic fluid cooler cannot lead to a mechanical overload of the hydraulic fluid cooler.

Alternatively or additionally, it can be provided that the bypass valve is adjustable between the closed position and the open position depending on a hydraulic fluid pressure, for example in the discharge line arrangement.

For this purpose, for example, the bypass valve can be open, preferably to a maximum extent, for flow when the hydraulic fluid pressure is above a switching pressure and can be at least partially, preferably completely, closed against flow when the hydraulic fluid pressure is below the switching pressure. This also ensures that excessive loading of the hydraulic fluid cooler does not occur, particularly during a cold start phase in which the hydraulic fluid has a comparatively high viscosity.

The bypass valve can comprise, for example:
a thermostatic valve, i.e. a valve which switches when a switching temperature is reached, for example,
or
a check valve, i.e. a valve which switches when a switching pressure is reached, for example,
or
a pressure-dependent and/or temperature-dependent electrically switchable valve, i.e. a valve which is subject to a control which takes into account the pressure of the hydraulic fluid and/or the temperature of the hydraulic fluid as an input variable and is switched accordingly in a pressure-dependent and/or temperature-dependent manner.

In the hydraulic drive system according to the invention, at least one hydraulic pump can be a hydraulic component to be flushed by means of at least one flushing line. Alternatively or additionally, at least one hydraulic motor can be a hydraulic component to be flushed by means of at least one flushing line.

It should be noted that, in the context of the present invention, hydraulic motors are not only understood to mean units that generate a drive torque for driving wheels, for example drive wheels or chain wheels or the like, but also any type of unit that generates a drive force or a drive torque by being subjected to a pressurized fluid. For example, in the context of the present invention, hydraulic piston/cylinder units which are used to move components or working devices on construction machines are also to be regarded as drive motors supplied with hydraulic fluid by means of one or more hydraulic pumps.

The invention furthermore relates to a ground processing machine, preferably a ground compactor, comprising a drive system constructed according to the invention.

The present invention is described in detail below with reference to the attached figures. In particular:

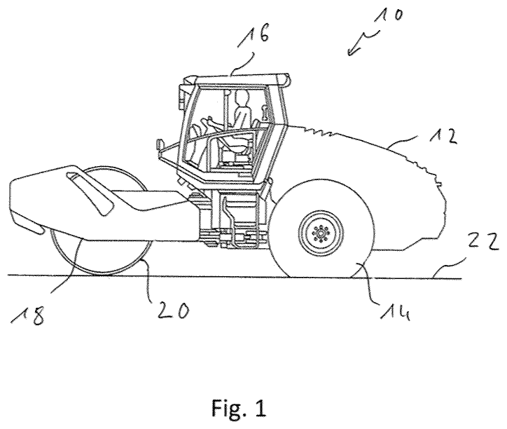

FIG. 1 shows a self-propelled construction machine designed as a ground compactor in side view;

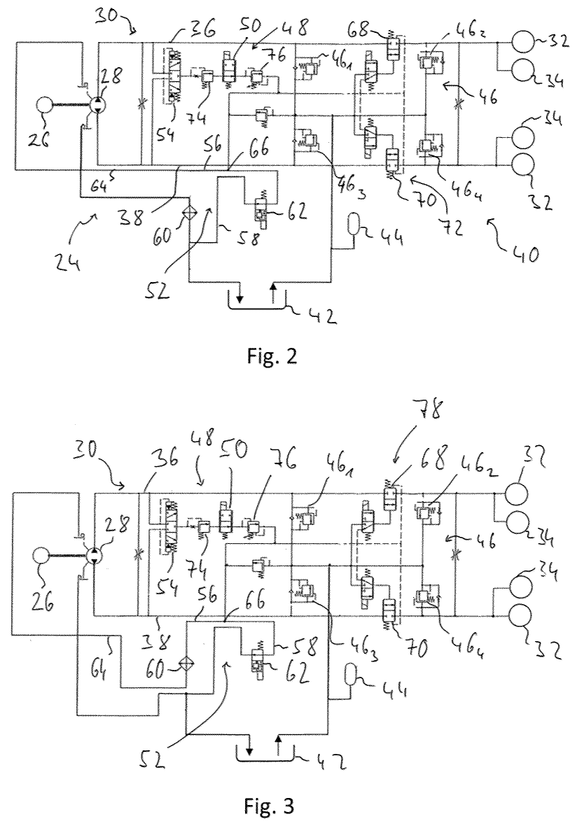

FIG. 2 a circuit diagram of a hydraulic drive system, for example for the construction machine shown in FIG. 1;

FIG. 3 shows a circuit diagram of an alternative embodiment of the hydraulic drive system, for example for the construction machine shown in FIG. 1.

FIG. 1 shows a side view of a self-propelled construction machine 10 designed as a ground compactor. The construction machine 10 comprises drive wheels 14 on both sides of a rear carriage 12 which can be rotationally driven by a drive unit also provided on the rear carriage 12. Furthermore, an operating station 16 for an operator operating the construction machine 10 is provided on the rear carriage 12.

A ground processing roller 20 is provided on a front carriage 18 which is pivotally connected to the rear carriage 12 for steering the construction machine 10. When the construction machine 10 moves over a substrate 22 to be processed, the ground processing roller 20 rolls on it. Depending on the surface design of the ground processing roller, it can compact the substrate 22 it passes over or, in the case of a structured surface, it can be used to break up a solid substrate, for example a concrete substrate.

Before a hydraulic drive system for such a ground processing machine 10 is described in detail below with reference to FIGS. 2 and 3, it should be pointed out that the self-propelled construction machine 10 shown in FIG. 1 is only one example of such construction machines. If the construction machine 10 is designed as a ground compactor, it could also have a ground processing roller on the rear carriage 12, wherein one or both ground processing rollers can then be rotationally driven in order to move the construction machine 10 over the substrate 22. It is also possible to design it as a pivot-steered ground compactor, a wheeled loader or similar. Such a construction machine 10 may also have crawler tracks, for example when designed as a bulldozer or the like.

In FIG. 2, a hydraulic drive system 24 for such a self-propelled construction machine 10 is shown with regard to its essential system regions. The hydraulic drive system 24 comprises a hydraulic pump 28 driven by a drive unit 26. In a conventional design, the drive unit 26 can be provided, for example, by a diesel internal combustion engine. If designed as an electro-hydraulic drive system, the drive unit can also comprise an electric motor.

The hydraulic drive system 24 further comprises a hydraulic circuit 30, via which, in the illustrated exemplary embodiment, two hydraulic motors 32, 34 are hydraulically connected to the hydraulic pump 28 in order to supply pressurized hydraulic fluid, generally hydraulic oil, to the latter or to supply hydraulic fluid back from the latter.

The hydraulic circuit 30 comprises a first line region 36 connecting the hydraulic pump 28 to the two hydraulic motors 32, 34 and a second line region 38 for connecting the hydraulic pump 28 to the two hydraulic motors 32, 34. Depending on the intended direction of movement and corresponding direction of rotation of the hydraulic motors 32, 34, the hydraulic fluid conveyed by the hydraulic pump 28 is conducted via the line region 36 to the hydraulic motors 32, 34 and supplied back to the hydraulic pump 28 via the second hydraulic region 38, or hydraulic fluid is conducted via the second line region 38 to the two hydraulic motors 32, 34, which, for example, in the construction machine 10 shown in FIG. 1 can each be associated with one of the drive wheels 14 arranged on the sides of the rear carriage 12, and is supplied back to the hydraulic pump 28 via the first line region 36.

Although the hydraulic circuit 30 shown in FIG. 2 is basically a closed circuit, it is necessary to replenish hydraulic fluid from a hydraulic fluid reservoir 42 or an associated pressure fluid reservoir 44 into the hydraulic circuit 30 or to discharge hydraulic fluid from the hydraulic circuit 30 in different states of the hydraulic drive system 24. The replenishment of hydraulic fluid may be necessary, for example, if the pressure in the hydraulic circuit 30, in particular on a low-pressure side, falls below an associated threshold value due to unavoidable leaks, for example in the hydraulic motors 32, 34 or in the hydraulic pump 28, or if hydraulic fluid is actively discharged, for example due to the temperature of the hydraulic fluid in the hydraulic fluid circuit being too high.

An infeed valve arrangement, generally designated 46, is provided for replenishing the hydraulic fluid. The infeed valve arrangement 46 comprises, in association with the first line region 36 of the hydraulic fluid circuit 30, two first infeed valves 46₁, 46₂, and comprises, in association with the second line region 38 of the hydraulic fluid circuit 30, second infeed valves 46₃, 46₄. Depending on whether check valves 68, 70 of a service brake 72 are in the blocked state shown in FIGS. 2 and 3, in which the service brake is active, or in a release state in which the hydraulic fluid conveyed by the hydraulic pump 28 can flow through the hydraulic motors 32, 34 via the line regions 36, 38, the hydraulic fluid resupplied from the hydraulic fluid reservoir 42 via a hydraulic pump (not shown in the figures) or from the pressure fluid reservoir 44 is resupplied into the hydraulic fluid circuit 30 via an infeed valve of the four infeed valves 46₁, 46₂, 46₃, 46₄ which is then connected to the low-pressure side in the respective operating state.

A discharge valve arrangement, generally designated 48, is provided for discharging the hydraulic fluid. This comprises a check valve 50 which either opens or interrupts the flow path to a discharge line arrangement generally designated 52 and, upstream of this, a control valve 54 which connects the check valve 50 selectively to the first line region 36, the second line region 38 or none of these line regions. In this way, it can be ensured that the discharge of hydraulic fluid always takes place on the low-pressure side of the hydraulic circuit 30, i.e. from that line region of the first line region 36 and the second line section 38, which is used to return the hydraulic fluid conveyed by the hydraulic pump 28 to the hydraulic pump 28 after flowing through the two hydraulic motors 32, 34. The discharge valve arrangement 48 further comprises pressure-maintaining valves 74, 76 in the flow direction between the two valves 50, 54 and downstream of the check valve 50, which ensure that the fluid pressure in the hydraulic fluid circuit 30 cannot fall below a certain minimum pressure level as a result of a discharge process.

The discharge line arrangement 52 comprises a discharge cooling line 56 and, parallel thereto, a discharge bypass line 58. Both the discharge cooling line 56 and the discharge bypass line 58 lead to the hydraulic fluid reservoir 42.

A hydraulic fluid cooler 60 is provided in the discharge cooling line 56, in which hydraulic fluid discharged from the hydraulic circuit 30 can transfer heat, for example, to the ambient air in order to cool at least a portion of the discharged hydraulic fluid before it is introduced into the hydraulic fluid reservoir 42.

A bypass valve 62 is provided in the discharge bypass line 58, which in a closed position preferably completely closes the discharge bypass line 58 against flow of hydraulic fluid, so that the entire discharged hydraulic fluid flows through the discharge cooling line 56 and the hydraulic fluid cooler 60 provided therein, and in its open position releases the discharge bypass line 58 to the maximum extent for flow of hydraulic fluid. Due to the comparatively low flow resistance of the bypass valve 62 in this state compared to the flow resistance of the hydraulic fluid cooler 60, a significant portion of the discharged hydraulic fluid will flow through the discharge bypass line 58 to the hydraulic fluid reservoir 42 when the bypass valve 62 is in the open position.

The bypass valve can be designed, for example, as a thermostatic valve which switches from its open position to its closed position when a switching temperature of the hydraulic fluid, for example in the range of approximately 60° C., is reached, so that when the temperature of the hydraulic fluid is below the switching temperature, the discharge bypass line 58 is released for flow and thus, in the case of comparatively viscous, i.e. thick hydraulic fluid, the load on the hydraulic fluid cooler 60 due to excessively high fluid pressure is avoided. When the switching temperature is reached, i.e. at a higher temperature and thus lower viscosity of the hydraulic fluid, the bypass valve 62 moves into its closed position, so that it is ensured that the hydraulic fluid directed towards the hydraulic fluid reservoir 42 is cooled to a sufficient extent when the pressure load on the hydraulic fluid cooler 60 is not excessively high.

In an alternative embodiment, the bypass valve 62 could be designed as a check valve which, when the temperature of the hydraulic fluid is lower and the viscosity of the hydraulic fluid is thus higher, is switched to its open position due to a comparatively large pressure drop, and when the temperature of the hydraulic fluid increases and the viscosity thus decreases, is switched to its closed position due to the then also decreasing pressure drop, and thus ensures that as the temperature of the hydraulic fluid increases, it is directed to flow through the hydraulic fluid cooler 60 into the discharge cooling line 56.

Furthermore, the bypass valve 62 could be designed as an electrically switchable valve controlled by a control unit. As an input variable for switching such a valve, the pressure of the hydraulic fluid and/or its temperature can again be taken into account, so that it is again ensured that when the temperature of the hydraulic fluid is comparatively low and the pressure drop building up at the hydraulic fluid cooler 60 is correspondingly comparatively large, the discharge bypass line 58 is released by opening such a valve and thus a larger part of the hydraulic fluid is diverted via the discharge bypass line 58 in order to avoid an excessive pressure build-up at the hydraulic fluid cooler 60. If the temperature and viscosity of the hydraulic fluid are sufficiently high and the pressure build-up at the hydraulic fluid cooler 60 is correspondingly low, the electrically switchable valve can be set to its closed position to ensure sufficient cooling of the hydraulic fluid discharged from the hydraulic circuit 30.

The bypass valve 62 can, regardless of its design, also be designed such that it carries out a substantially continuous transition between its open position and its closed position depending on the temperature and/or pressure, so that, coming from a cold start phase with comparatively cold and therefore viscous hydraulic fluid, the bypass valve 62 gradually changes from its open position to its closed position with increasing temperature and correspondingly decreasing viscosity of the hydraulic fluid and thus an increasing proportion of the discharged hydraulic fluid flows via the hydraulic fluid cooler 60.

Since the pressure-dependent or temperature-dependent adjustment of the bypass valve 62 primarily serves to protect the hydraulic fluid cooler 60 from overload and possible associated damage, the variable taken into account for adjusting the bypass valve 62, i.e. the temperature or pressure, can be detected, for example, in the region of the hydraulic fluid cooler 60. For example, pressure sensors may be provided upstream and downstream of the hydraulic fluid cooler 60 in the discharge cooling line 56 in order to detect the pressure difference occurring at the hydraulic fluid cooler 60 and to open or close the bypass valve 62 depending thereon. The temperature of the hydraulic fluid can also be detected in the region of the hydraulic fluid cooler 60, for example upstream thereof, if it is taken into account as a control variable. Of course, it is also possible to take into account temperature and/or pressure values in other regions of the hydraulic circuit 30, for example in the region of the hydraulic fluid reservoir 42, if these allow sufficient conclusions to be drawn about the temperature-dependent or pressure-dependent mechanical load on the hydraulic fluid cooler 60.

The hydraulic drive system 40 further comprises a flushing line 64, which in the exemplary embodiment shown in FIG. 2 branches off from the discharge cooling line 56 upstream of the hydraulic fluid cooler 60 or provides a line region of the discharge line arrangement 52 or of the discharge cooling line 56 located upstream of the hydraulic fluid cooler 60. Via the flushing line 64, hydraulic fluid flowing through the discharge cooling line 56 is directed to a hydraulic component of the hydraulic drive system 40 which is to be flushed with hydraulic fluid and thus also to be cooled. In the exemplary embodiment shown in FIG. 2, the hydraulic pump 28 forms such a hydraulic component to which hydraulic fluid discharged from the hydraulic circuit 30 is supplied in order to dissipate heat generated in the region of the hydraulic pump 28 and to cool the fluid absorbing the heat in the hydraulic fluid cooler 60 before it is introduced into the hydraulic flushing reservoir 42.

Since in the illustrated exemplary embodiment the hydraulic pump 28 is also a hydraulic component which is to be protected from excessively high pressures, particularly in the system regions through which the hydraulic fluid flows, it is particularly advantageous to integrate the flushing line 64 into the discharge cooling line 56 or to branch off from it, since due to the previously described function of the bypass valve 62 the discharge cooling line 56 and thus also the flushing line 64 is only flowed through by the discharged hydraulic fluid or a larger part of it when its temperature is sufficiently high or its viscosity is sufficiently low. For this reason, it is also advantageous, for example, to detect the temperature or pressure of the discharged hydraulic fluid upstream of the flushing line 64 or upstream of the hydraulic component to be flushed or cooled by means of the flushing line 64 when the bypass valve 62 is switched in a temperature-dependent or pressure-dependent manner. For example, at a branching point 66, i.e. where in the discharge line arrangement 52 the discharge bypass line 58 on the one hand and the discharge cooling line 56 or the flushing line 64 on the other hand branch off from each other, a temperature sensor or a pressure sensor could be provided to detect the respective variable to be taken into account.

Another alternative embodiment of the hydraulic drive system 40 is shown in FIG. 3. This corresponds in particular with regard to the structure of the hydraulic circuit 30 to the embodiment of FIG. 2, so that reference can be made to the above explanations.

A significant difference from the embodiment shown in FIG. 2 is that the flushing line 64 branches off from the discharge cooling line 56 downstream of the hydraulic fluid cooler 60 or forms a line region of the discharge cooling line 56 downstream of the hydraulic fluid cooler 60. This variant has the advantage that the hydraulic fluid discharged from the hydraulic circuit 30 and introduced into the discharge cooling line 56 is already cooled in the hydraulic fluid cooler 60 before flowing through the hydraulic component to be cooled, in the illustrated exemplary embodiment the hydraulic pump 28, so that a more efficient cooling of the hydraulic component, in this case the hydraulic pump 28, can be realized.

In principle, the flushing line 64 could also be routed parallel to the hydraulic fluid cooler 60 and thus, of course, also parallel to the hydraulic bypass line 58. As shown in FIG. 2, the flushing line 64 could branch off from the discharge cooling line 56 upstream of the hydraulic fluid cooler 60 and, as shown in FIG. 3, flow back into the discharge cooling line 56 downstream of the hydraulic fluid cooler 60. In this variant too, the system regions of hydraulic fluid cooler 60 and hydraulic pump 28, which are then flown through in parallel to each other, are only flowed through by discharged hydraulic fluid when the discharge cooling line 56 is released for flow with a significant portion of the discharged hydraulic fluid or the discharge bypass line 58 is closed off against flow by the bypass valve 62.

It is also possible to combine the two variants shown in FIGS. 2 and 3 in order to cool multiple hydraulic components of the hydraulic drive system 40 with discharged hydraulic fluid. Furthermore, a plurality of hydraulic components to be cooled can be integrated in series and/or parallel to one another in the flushing line 64 in order to not cool or not only cool the hydraulic pump 28 but also, for example, the hydraulic motors 32, 34 by means of the discharged hydraulic fluid.

1. A hydraulic drive system, in particular for a self-propelled construction machine, comprising:
at least one hydraulic pump driven by a drive unit for conveying hydraulic fluid,
a hydraulic circuit receiving hydraulic fluid conveyed by the at least one hydraulic pump and returning hydraulic fluid to the at least one hydraulic pump,
at least one hydraulic motor supplied via the hydraulic circuit with hydraulic fluid conveyed by the at least one hydraulic pump,
a discharge line arrangement for discharging hydraulic fluid from the hydraulic circuit to a hydraulic fluid reservoir,
at least one flushing line supplied from the hydraulic circuit for flushing at least one hydraulic component of the hydraulic drive system with hydraulic fluid,
wherein at least one flushing line branches off from the discharge line arrangement and/or forms a line region of the discharge line arrangement.

2. The hydraulic drive system according to claim 1,
wherein the discharge line arrangement comprises a discharge cooling line containing a hydraulic fluid cooler and leading to the hydraulic fluid reservoir, and a discharge bypass line leading parallel to the discharge cooling line to the hydraulic fluid reservoir, and that at least one flushing line branching off from the discharge line arrangement branches off from the discharge cooling line and/or forms a line region of the discharge cooling line.

3. The hydraulic drive system according to claim 2,
wherein at least one flushing line branches off from the discharge cooling line upstream of the hydraulic fluid cooler and/or forms a line region of the discharge cooling line located upstream of the hydraulic fluid cooler.

4. The hydraulic drive system according to claim 3,
wherein at least one flushing line is arranged parallel to the hydraulic fluid cooler.

5. The hydraulic drive system according to claim 2,
wherein at least one flushing line branches off from the discharge cooling line downstream of the hydraulic fluid cooler and/or forms a line region of the discharge cooling line located downstream of the hydraulic fluid cooler.

6. The hydraulic drive system according to claim 2,
wherein at least one flushing line is arranged in series to the hydraulic fluid cooler.

7. The hydraulic drive system according to claim 2,
wherein a bypass valve is associated with the discharge bypass line, wherein the bypass valve is adjustable between a closed position which closes off the discharge bypass line against flow of hydraulic fluid, and an open position which releases the discharge bypass line for flow of hydraulic fluid.

8. The hydraulic drive system according to claim 7,
wherein the bypass valve is adjustable between the closed position and the open position depending on a hydraulic fluid temperature.

9. The hydraulic drive system according to claim 8,
wherein the bypass valve is open for flow when the hydraulic fluid temperature is below a switching temperature, and is at least partially closed to prevent flow when the hydraulic fluid temperature is above the switching temperature.

10. The hydraulic drive system according to claim 7,
wherein the bypass valve is adjustable between the closed position and the open position depending on a hydraulic fluid pressure.

11. The hydraulic drive system according to claim 10,
wherein the bypass valve is open for flow when the hydraulic fluid pressure is above a switching pressure, and is at least partially closed to prevent flow when the hydraulic fluid pressure is below the switching pressure.

12. The hydraulic drive system according to claim 7,
wherein the bypass valve comprises:
a thermostatic valve,
or
a check valve,
or
a pressure-dependent and/or temperature-dependent electrically switchable valve.

13. The hydraulic drive system according to claim 1,
wherein at least one hydraulic pump is a hydraulic component to be flushed by at least one flushing line.

14. The hydraulic drive system according to claim 1,
wherein at least one hydraulic motor is a hydraulic component to be flushed by means of at least one flushing line.

15. A ground processing machine, comprising a hydraulic drive system according to claim 1.
